(19) United States
(12) Patent Application Publication
(10) Pub. No.: US 2008/0218814 A1
(43) Pub. Date: Sep. 11, 2008

(54) Color Proofing Method

(76) Inventor: Andrew Rodney Ferlitsch, Camas, WA (US)

Correspondence Address: KIRTON & MCCONKIE, 1800 EAGLE GATE TOWER / 60 EAST SOUTH TEMPLE, P.O. BOX 45120, SALT LAKE CITY, UT, 84145-0120, US

(21) Appl. No.: 11/684,582

(22) Filed: Mar. 9, 2007

(51) Int. Cl. H04N 1/46

(52) U.S. Cl. 358/500

(57) ABSTRACT

Embodiments of the invention provide an effective method for color proofing by outputting multiple reduced or full-size versions of some selected sample of a color rendering job using different color attribute settings for each of the multiple versions. The color attribute settings may be user selected, automatically selected, or a combination of the two. A new rendering job is then generated, with each image in the new job representing one set of settings for the sample. The new rendering job may be rendered as an N-up job, where each scaled 1/Nth image shows one of the different sets of color attribute settings for the sample. Each image may include an identifier, so the user can select one image and then enter or select the identified settings in the driver. Once desired color rendering has been achieved, the entire color-adjusted rendering job may be output to the rendering device.

### BACKGROUND OF THE INVENTION

1. Field of the Invention

The present invention relates to color printing and rendering, and more particularly to proofing of color prints and displays to obtain desirable color rendering of a print job or other color output or display.

2. Background and Related Art

When a user of a color printer desires a high quality color output, the user might use some form of color adjustment controls and sample proofs to obtain the desired color rendering before making the final copy. Traditionally, as illustrated in FIG. 1, this has been a laborious task. A user might use a printer driver with some color adjustment controls. Generally, the user sets the color adjustment controls before the printer driver receives the print data. Thus, the printer driver has no means to provide immediate feedback on the effect of the changes before rendering the image to a hardcopy output.

Instead, the user has to view a sampled printed output (e.g., one page, one copy). If the color rendering is the desired rendering, the user can then make the remaining hardcopy outputs. Otherwise, the user must make additional adjustments, based on the visual observation of the proof output, and reprint another proof sample. This process has to be repeated until the desired rendering is obtained.

This method is limited in that: (1) the user must invoke N-cycles of proof print and review, where N is the number of repetitive cycles it takes to obtain the desired proof color rendering; (2) if the printer is not in the immediate vicinity of the user, the user may have to walk N times some distance to the printer and back, and (3) during the iterative N-cycle, the printer is preoccupied with proof generation.

An improvement to the above is demonstrated in U.S. Patent Application Publication No. 2005/0286063 to Owen et al. entitled Systems and Methods for Segmenting Pages and Changing Settings for Graphical Elements in Printing. In the improved method, as illustrated in FIG. 2, the printer driver journals all or an initial sample of the print stream prior to the user making color adjustment settings. When the user makes a color adjustment change, the printer driver simulates the device rendering of the sampled print data in a print preview display. The user can then use the print preview display for immediate feedback while making adjustments, without generating a hardcopy proof.

Once the user achieves and views the desired simulated rendering, the user can then instruct the printer driver on the final color adjustment settings, and the printer driver can proceed to generate a print job for the sampled and remaining part of the job. However, this method is limited in that the display and printer typically have different color gamut spaces and mappings. The simulation is at best an approximate conversion from the printing device's color space to the display color space. The final output therefore may not be exactly identical to what was observed in the display, and additional proofing and re-printing may be required to obtain the desired color rendering.

### BRIEF SUMMARY OF THE INVENTION

Embodiments of the invention provide an effective method for color print/output proofing.

When adjusting the color attributes (e.g., brightness and contrast) controls in a driver, it is difficult to know how changes in color attributes are going to affect the color rendering of the output. Embodiments of the inventive system output multiple reduced or full-size versions of some selected sample of the rendering job (e.g., the first page) as a single output job and using different color attribute settings for each of the multiple versions.

In one embodiment, the user selects different sets of color attribute settings, in another the driver selects from a predetermined set of color attribute settings, and in still another embodiment the user selects sets of color attribute settings and the driver selects others. In some embodiments, the driver may then generate an N-up rendering job, where each scaled 1/Nth image has one of the different sets of color attribute settings applied to the sample image. Each 1/Nth image may be printed (or displayed) with an identifier (e.g., an annotation on or below the reduced image), so the user can select one image having a most desirable rendering and then enter or select the identified settings in the driver. Alternatively, rather than printing an N-up print job, the sample image may be printed/displayed at full size but with multiple copies, each using a different set of color attribute settings and having an identifier.

The driver then adjusts the color attributes of the entire rendering job according to the set of color attribute settings associated with the selected identifier. In some embodiments, the user may also make additional changes relative to the selected setting (e.g., add more blue), or may repeat the proofing process with changed settings to obtain the best color rendering. Once desired color rendering has been achieved, the entire color-adjusted rendering job may be output to the printing/rendering device. Embodiments of the invention may include or be used in conjunction with any soft- or hard-copy color rendering device, including printers, copiers, facsimile devices, multifunction peripherals, and short-term display devices such as projectors, electronic whiteboards, and monitors.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a flow diagram of a current method for adjusting color settings for a print output to improve color rendering;

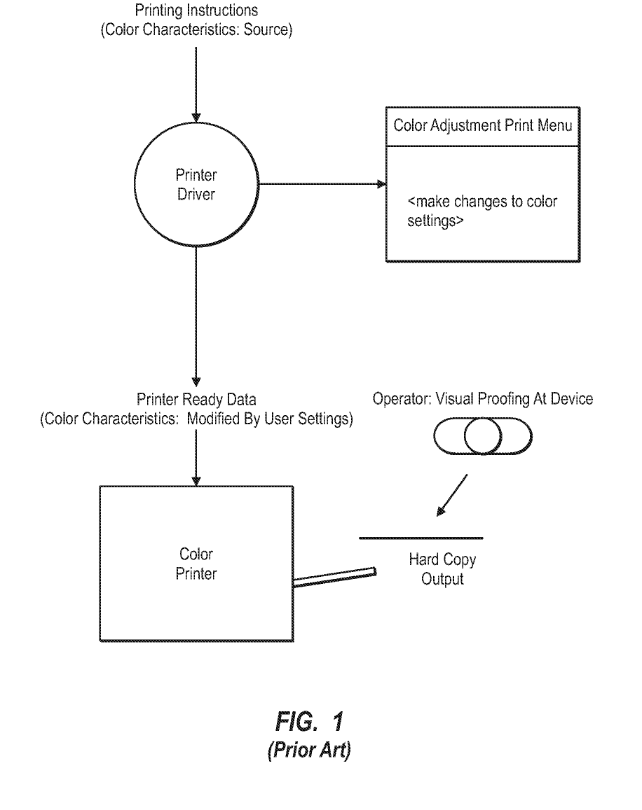

FIG. 2 shows a flow diagram of an alternative current method for adjusting color settings for a print output to obtain improved color rendering;

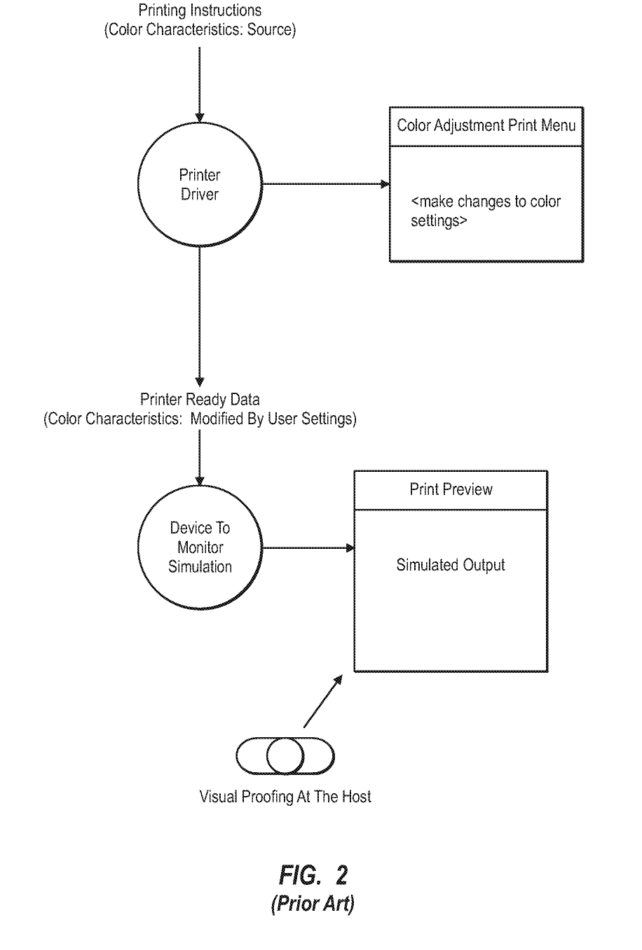

FIG. 3 illustrates a representative system that provides a suitable operating environment for use with the present invention;

FIG. 4 illustrates a representative system configuration in association with embodiments of the present invention;

FIG. 5 shows an exemplary operating environment for color print proofing;

FIG. 6 depicts an exemplary color adjustment settings repository;

FIG. 7 illustrates automatic selection of color adjustment settings;

FIG. 8 illustrates user selection of color adjustment settings;

FIG. 9 illustrates user selection of color adjustment settings;

FIG. 10 illustrates automatic selection of color adjustment settings;

FIG. 11 illustrates automatic selection of color adjustment settings;

FIG. 12 shows rendering a sample proof using a set of N selected color adjustment settings;

FIG. 13 shows using a selected set of color adjustment settings in conjunction with a full print job; and

FIG. 14 shows using an automatically-selected set of N color adjustment settings to generate sample proof sheet(s).

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the invention provide an effective method for proofing of color rendering such as color prints and other color outputs.

In the specification and in the claims, the terms “color attribute settings” and “color adjustment settings” are used interchangeably.

When adjusting the color attributes (e.g., brightness and contrast) controls in a driver, it is difficult to know how changes in color attributes are going to affect the color rendering of the output. Embodiments of the inventive system output multiple reduced or full-size versions of some selected sample of the rendering job (e.g., the first page) as a single output job and using different color attribute settings for each of the multiple versions.

In one embodiment, the user selects different sets of color attribute settings, in another the driver selects from a predetermined set of color attribute settings, and in still another embodiment the user selects sets of color attribute settings and the driver selects others. In some embodiments, the driver may then generate an N-up rendering job, where each scaled 1/Nth image has one of the different sets of color attribute settings applied to the sample image. Each 1/Nth image may be printed (or displayed) with an identifier (e.g., an annotation on, below, above, or to the side of the reduced image), so the user can select one image having a most desirable rendering and then enter or select the identified settings in the driver. Alternatively, rather than printing an N-up print job, the sample image may be printed/displayed at full size but with multiple copies, each using a different set of color attribute settings and having an identifier.

The driver then adjusts the color attributes of the entire rendering job according to the set of color attribute settings associated with the selected identifier. In some embodiments, the user may also make additional changes relative to the selected setting (e.g., add more blue), or may repeat the proofing process with changed settings to obtain the best color rendering. Once desired color rendering has been achieved, the entire color-adjusted rendering job may be output to the printing/rendering device. Embodiments of the invention may include or be used in conjunction with any soft- or hard-copy color rendering device, including printers, copiers, facsimile devices, filing devices, format converters, multifunction peripherals, duplication devices, and short-term display devices such as projectors, electronic whiteboards, and monitors.

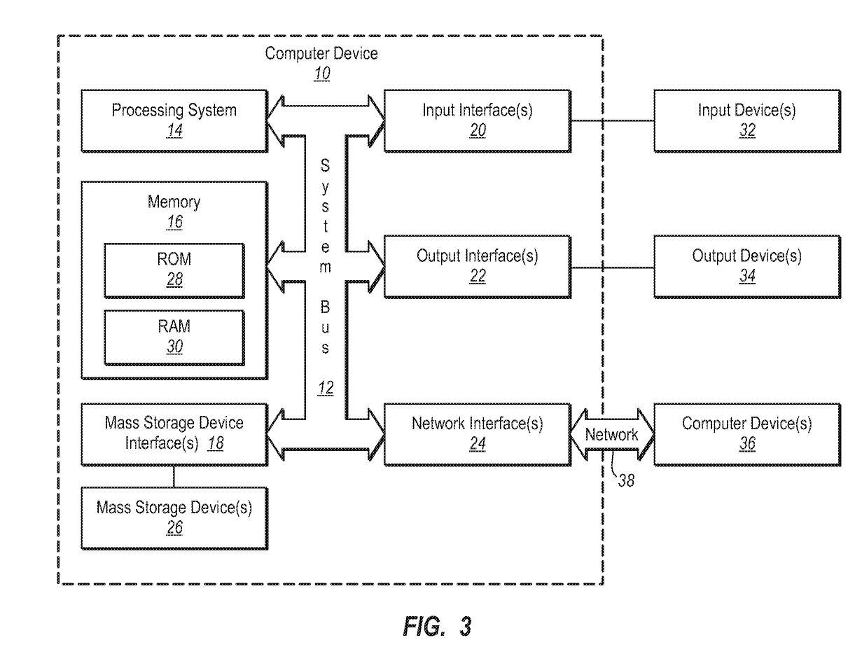

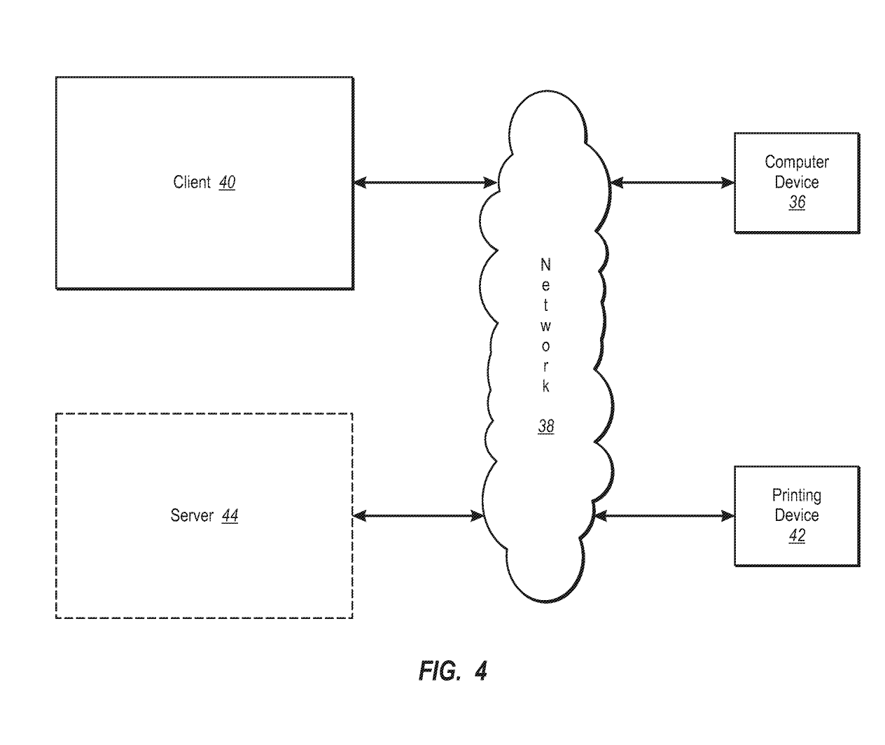

Inasmuch as at least some embodiments of the present invention embrace utilization of a computer device, FIGS. 3 and 4 and the corresponding discussion are intended to provide a general description of some suitable operating environments in which the invention may be implemented. One skilled in the art will appreciate that the invention may be practiced by one or more computing devices and in a variety of system configurations, including in a networked configuration.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), non-volatile random-access memory (“NVRAM”), read-only memory (“ROM”), programmable read-only memory (“PROM”), erasable programmable read-only memory (“EPROM”), electrically erasable programmable read-only memory (“EEPROM”), flash memory (e.g., a USB thumb-drive), compact disk read-only memory (“CD-ROM”), magnetic memory (e.g., a hard drive), or any other device or component that is capable of providing data or executable instructions that may be accessed by a processing system.

With reference to FIG. 3, a representative system for implementing the invention includes computer device 10, which may be a general-purpose or special-purpose computer. For example, computer device 10 may be a personal computer, a notebook computer, a personal digital assistant (“PDA”), cellular camera phone, digital camera or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, a flash memory device, or from a communication connection, which may also be viewed as a computer readable medium.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives, flash memory devices, and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

Memory 16 may include one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, a bioreader sensor, and the like. Similarly, examples of input interfaces 20 that may be used to connect the input devices 32 to the system bus 12 include a serial port, a parallel port, a game port, a universal serial bus (“USB”), IEEE 1394, IRDA, Bluetooth, Wi-Fi, Wi-MAX or another interface.

One or more output interfaces 22 may be employed to connect one or more corresponding output devices 34 to system bus 12. Examples of output devices 34 include a monitor or display screen, a printer, a plotter, a multi-function device, or other output device. A particular output device 34 may be integrated with or peripheral to computer device 10. Examples of output interfaces 22 include a video adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces 24 include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

While those skilled in the art will appreciate that embodiments of the present invention may be practiced in a variety of different environments with many types of computer system configurations, FIG. 4 represents a representative networked system configuration that may be used in association with an embodiment of the present invention. While FIG. 4 illustrates an embodiment that includes a client 40, a computer device 36, a printing device 42, and optionally a print server 44 connected to a network 38, alternative embodiments include more than one client 40, a plurality of printing devices 42, no server 44, and/or more than one server 44 connected to the network 38. Other embodiments of the present invention include local, networked, or peer-to-peer printing environments where one or more computer devices 36 are locally connected to one or more printing devices 42. Moreover, embodiments in accordance with the present invention also include wireless networked environments, or where the network 38 is a wide area network, such as the Internet. Further, printing device 42 may be a multi-function printer (MFP), a facsimile device, a filing device, or any other type of printing device.

In some embodiments, all processing relating to color print proofing may be performed by applications on client 40 or by another computer device 36. In other embodiments, some or all processing relating to color print proofing may be performed by applications on server 44. In still further embodiments, some or all processing relating to providing improved color proofing may be performed on the printing device 42. For example, there has been a recent increase in the number of printing devices that allow users to perform walk-up print jobs without using a separate client 40, server, 44, or other computer device 36. It is considered advantageous to provide a printing device, whether connected by a network to other computer systems or acting as a stand-alone printing device, with the ability to receive digital or other input to be printed (e.g. a walk-up print job) and to perform color proofing and color rendering adjustments in the manner disclosed herein, either in conjunction with a connected computer device or as an internal function of the printing device. Those skilled in the art will readily appreciate from the description below the many ways and system configurations in which the present invention may be practiced.

Thus, in accordance with the illustrated embodiment and other embodiments of the present invention, an effective and efficient system and method may be provided for color proofing, as will be further explained below.

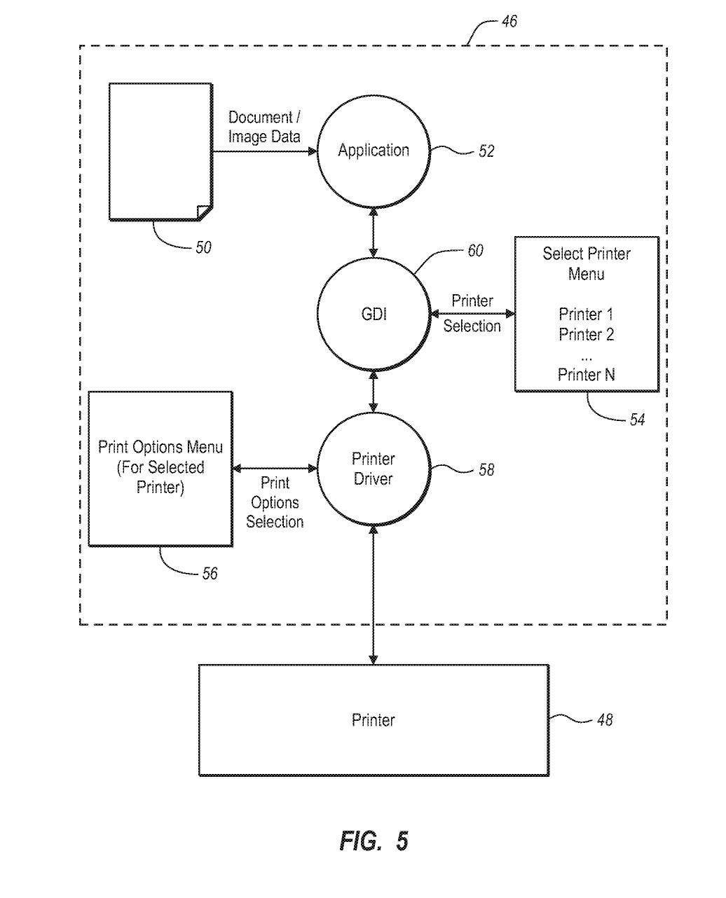

FIG. 5 illustrates, in an alternative fashion, an exemplary operating environment for color print proofing. The exemplary operating environment includes a print generation system 46 on a host (or other device) and a printer 48. As discussed above, in some embodiments, the print generation system 46 may be included as an integral part of the printer. The print generation system 46 may consist of any standard or custom print generation system, such as: (1) the Microsoft Windows® GDI print subsystem, (2) the Apple Macintosh® print subsystem, (3) the UNIX®/Linux™ CUPS print subsystem, and (4) the Microsoft Windows Vista™ XPS print subsystem. While any print generation system may be used with embodiments of the invention, the Microsoft Windows® print subsystem is used herein to describe embodiments of the invention.

The printer 48 may be any kind of printing device that produces either a hardcopy or other rendered output, where there is some color conversion/adjustment made between the source image and the rendered image, such as: printers, copiers, facsimile devices, multifunction peripherals, document/image servers, electronic whiteboards, filing devices, format converters, duplication devices, and digital projection systems. While any kind of printing device that produces a hardcopy, softcopy, or other rendered output may be used with embodiments of the invention, a hardcopy output printer is used herein to describe embodiments of the invention.

In some embodiments, a user desiring to print a document or image(s) opens the document/image file(s) 50 (“file 50,” “document 50,” or “image data 50”) in an application 52 that supports the native format of the document 50 (e.g., Microsoft Word, PDF, TIFF, etc.). The user then instructs the application 52 to print all, or some part of, the document 50 loaded into the application 52. The application 52 responds by displaying a print menu, that may include a select printer menu 54, where the user selects an installed printer 48 and may also include a print options menu 56 for selecting some set of settings specific to a printer driver 58 associated with the installed printer 48.

In some embodiments, the user may select or construct one or more sets of color attribute settings or color adjustment settings, before the application 52 converts the native format of the document 50/image data 50 into the operating system's graphical primitives 60 (e.g., GDI in Microsoft Windows® or XPS in Microsoft Windows Vista™) and passes them to the printer driver 58. In other embodiments, the user may select or construct the one or more sets of color attribute settings after the application 52 has passed some or all of the graphical primitives 60 to the printer driver 58. In the latter case, the printer driver 58 would journal (i.e., record as-is without processing, or convert to an intermediate format) some or all of the graphical primitives 60.

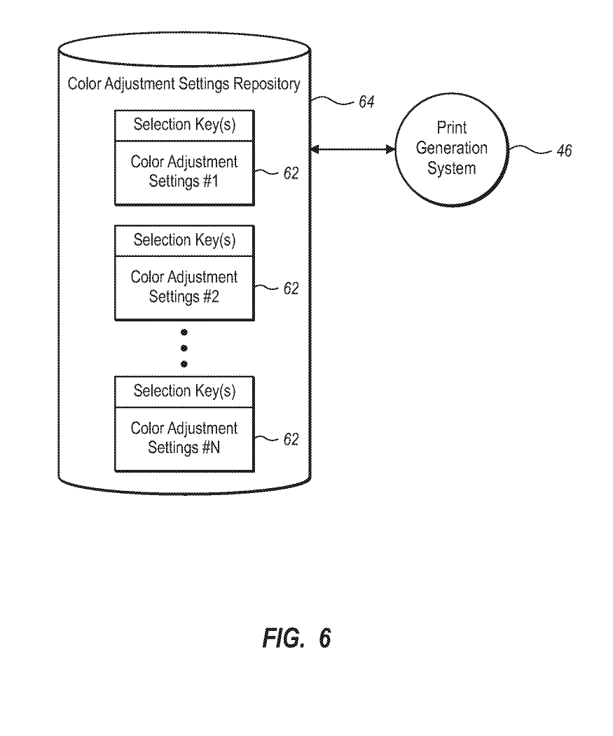

In some embodiments of the invention, as illustrated in FIG. 6, the print generation system 46, or a portion thereof, such as the printer driver 58 in the Microsoft GDI or XPS print subsystems, has a means for storing multiple sets of color attribute settings 62. These sets of color attribute settings 62 may be predefined or may be specified by the user on-the-fly. The collection of these sets of color attribute settings 62 is herein referred to as a color adjustment settings repository 64, or simply “repository 64.” The repository 64 may reside internal to the print generation system 46 (e.g., printer driver 58), or external to the print generation system 46. The repository 64 may be stored temporarily (e.g., in RAM) or persistently (e.g., on a hard drive, flash memory, etc.).

Examples of color adjustments that may be included in color attribute settings 62 include, but are not limited to: (1) increase/decrease brightness, (2) increase/decrease contrast, (3) increase/decrease blue hue, (4) increase/decrease saturation, and (5) shift color matching in the device's gamut. If the collection of color attribute settings 62 are predefined (that is, not selected by the user), they may come from a variety of sources including, but not limited to (1) the supplier (e.g., manufacturer) of the print subsystem, printing device/printer 48, or printing application 52, (2) an entry by a device administrator, or (3) a remote source, such as the Internet, via a download.

If the color attribute settings 62 are dynamically entered by the user (e.g., on-the-fly or for a particular job), the color attribute settings 62 may be used temporarily, specific to the current job, then discarded after the current job has been completed. In some embodiments, the user may additionally have the option to save all, or some subset, of the color attribute settings 62 to a persistent portion of the repository 64.

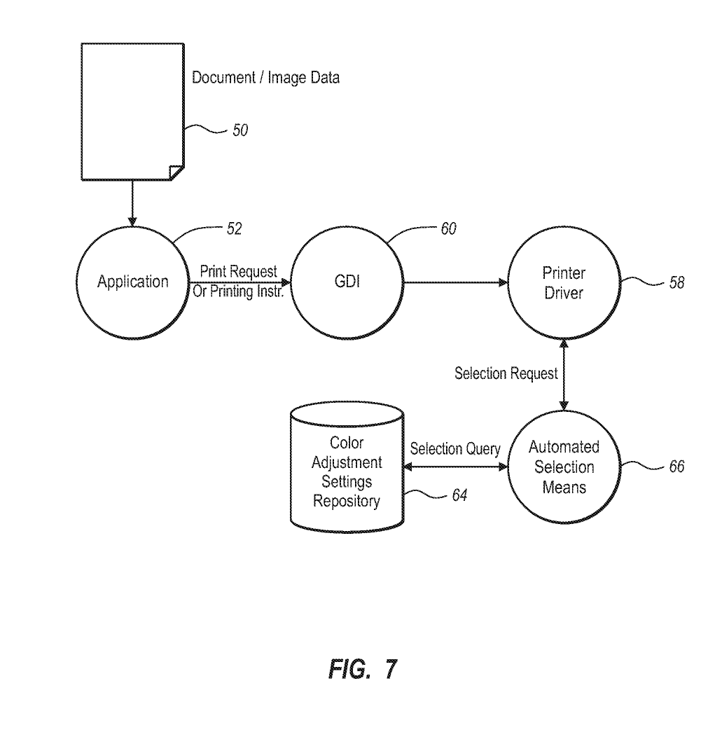

In some embodiments of the invention, as illustrated in FIG. 7, selection of a collection of sets of color adjustment settings/color attribute settings 62 may be performed automatically (i.e., without user input) and may occur before, during or after the printer driver 58 receives the printing instructions for the document/image data 50. In this method, the printer driver 58 communicates with the repository 64 to receive the collection of sets of color attribute settings 62 selected by a means 66 for automatically selecting color adjustment settings. The number of sets of color attribute settings 62 in the collection may be predefined or may be selected by the user. For example, the user or system might select 2, 4 or 8 different sets of color attribute settings 62. The automatic selection of the sets may be based on any algorithm, such as (1) predefined (i.e., always the same collection), (2) randomly selected (i.e., changes each time), or (3) heuristically selected—based on past performance, such as those color adjustment sets that have been most frequently selected for the final output or on an input source (e.g., MS-Word document). One of ordinary skill in the art will readily recognize other algorithms or methods for selecting sets of color attribute settings 62 for inclusion in the collection.

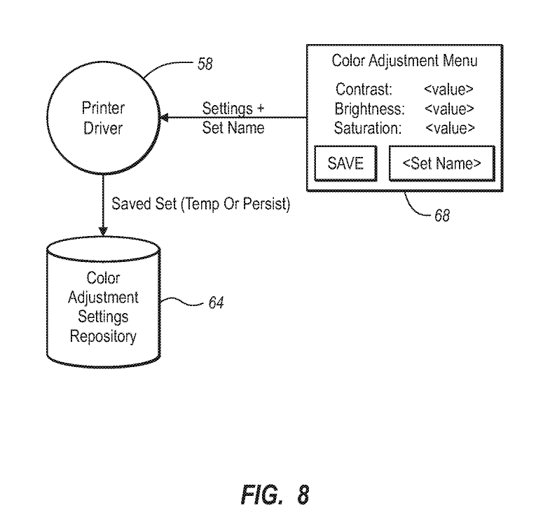

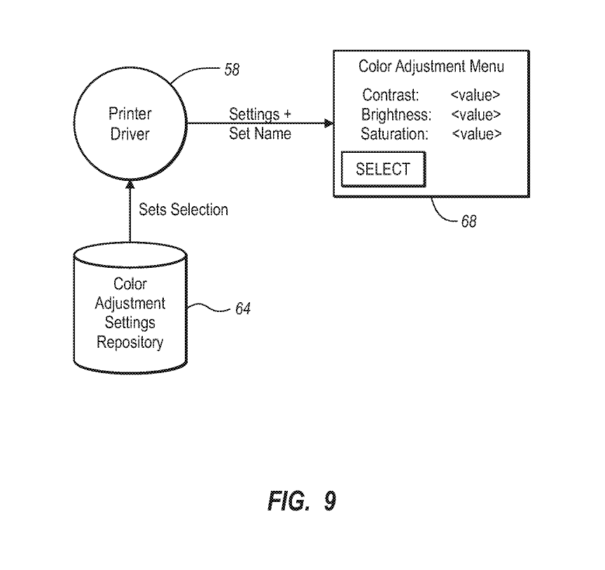

FIGS. 8 and 9 illustrate an alternative selection of color attribute settings 62 for inclusion in the collection, namely, user selection of a collection of color attribute settings. In some embodiments, the collection (sets) of color attribute settings 62 may be performed manually by the user and may occur before, during or after the printer driver 58 receives the printing instructions for the document/image data 50. In this method, the user interacts with the printer driver 58 to specify one or more sets of color attribute settings 62. The user may do this by (1) selecting sets of color adjustments from the predefined sets in the repository 64, (2) selecting sets of color adjustments from those previously entered by the user or another user, which are user- or group-specific (non-global) in the repository 64, (3) manually constructing new sets, such as by specifying settings in the printer driver's color adjustment dialogs 68, and then saving each set of settings temporarily or persistently to the repository 64, or (4) any combination of the above.

If the selection of settings is during or after the printer driver 58 has received the printing instructions, the user may also receive feedback via a print preview, which simulates the rendering of some sample of the document/image data 50 according to the selected color attribute settings 62 (as discussed in more detail below).

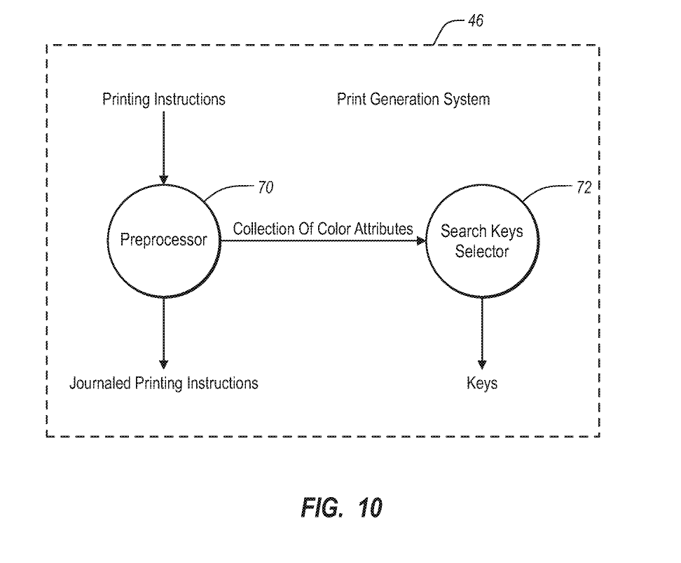

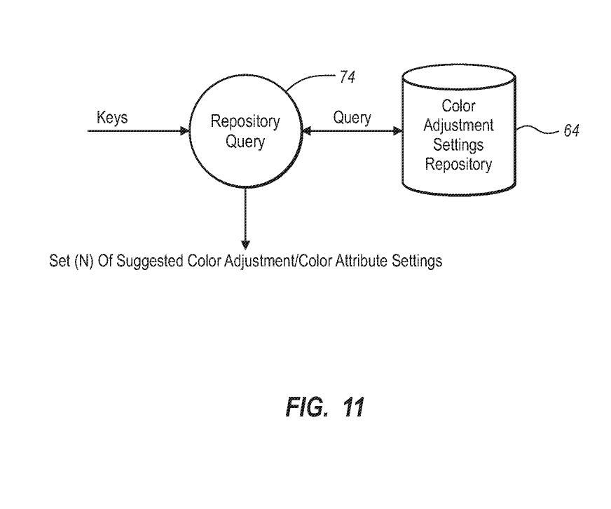

In some embodiments of the invention, as illustrated in FIGS. 10 and 11, the selection (or a portion of the selection) of a collection of sets of color attribute settings 62 may be done automatically based on a best-fit algorithm after an initial sample, or all, of the printing instructions are received by the printer driver 58. The printer driver 58 may journal, or convert to an intermediate form, all or an initial sample (e.g., first page) of a print job. The sample is then analyzed, as in FIG. 10, by a preprocessor 70 to identify color characteristics in the print job that may be suggestive of best-fit set(s) of color attribute settings 62.

Examples of color characteristics that may be suggestive of best-fit sets of color attribute settings 62 include, but are not limited to: (1) graphics vs. non-graphics (e.g., text only), (2) business graphics (e.g., synthetic images) vs. photographic (e.g., natural images) graphics, (3) daytime vs. nighttime illumination, (4) oversaturation of a particular color, (5) edge detection, (6) artifact detection (from lossy compression), (7) text overlayed on images, (8) mixed text and images, and (9) noise detection (despeckle). The printer driver 58 may use some means of weighting each color characteristic perceived in the sampled data. The weights can then be used by a search keys selector 72 to generate keys to be used as a search query into the repository 64.

Each set of color attribute settings 62 in the repository 64 may have associated with it a weight (such as a normalized scale of 0 to 1 of likelihood of match) for each color characteristic. If the set of color attribute settings 62 is predefined, then the weights associated with it may also be predefined. If the set of color attribute settings 62 is user-entered, the user may enter weights associated with it as well. If the color attribute settings 62 are based on past heuristics, then the weights may be the average of the color characteristics of the print jobs with which the color attribute settings 62 are associated.

A color attribute setting search 74 may then query the repository 64, as illustrated in FIG. 11, to find the best-fit matches from the color characteristics of the sample to those in the repository, and may rank the matches according to the best fit. The search method then selects the N highest-ranked matches, where N is a predefined number or a number entered or selected by the user.

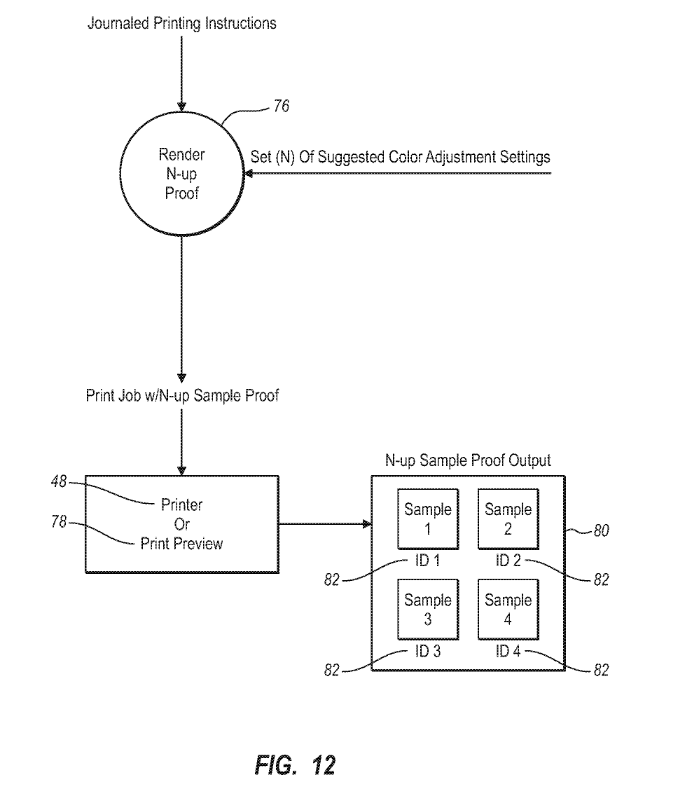

As is illustrated in FIG. 12, regardless of the method of selecting a collection of sets of color attribute settings 62 to be applied to a job, a sample proof output may be provided to allow the user to select the color attribute settings 62 providing the best color rendering of the job. In some embodiments, the user may view the effects of each set of color attribute settings 62 on the full job or on a representative sample in a print preview 78. The printer driver 58 may accomplish this by simulating the device's rendering of the journal data of the sample according to each set of color attribute settings 62 at step 76.

The print preview 78 may then display the simulated rendering of each sample either as a full image or as a reduced image. For each displayed full or reduced image, the user may be provided an opportunity to make additional color adjustments relative to the color attribute settings 62 associated with the simulated rendering. The user may also select all or a subset of the simulated renderings for final proof output, whether hardcopy or otherwise. Additionally, the user may request to replace or add additional sets of color attribute settings 62 from the repository 64, or may manually add sets of color attribute settings 62.

Once the user has selected all, or a subset of, the sets of color attribute settings 62 (with or without a print preview 78), the user may request the printer driver 58 to generate a proof sheet 80 or set of proof sheets 80 to the color printer 48. The color printer 48 then creates a print job with one or more color-adjusted samples per proof sheet 80. If only one sample is printed per proof sheet 80, each sample image may be printed at full resolution; otherwise, each sample image may be printed at a reduced resolution. The output may also be duplex (double-sided printing) to maximize the number of sample images per sheet of paper used. The number of sample images per proof sheet 80 can be selected by, but not limited to, (1) N-up, where N is the number of sample images, (2) N-up, where N is some predefined number (e.g., 4), (3) N-up, where N is user entered, or (4) 1-up, full resolution. The proof sheet(s) 80 containing the samples with color adjustments on them may be printed simultaneously as a single job so that the user need not engage in multiple cycles of proof review and color adjustment.

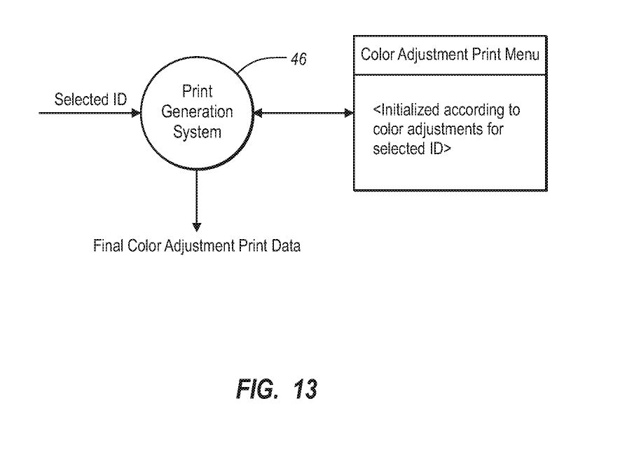

On the proof sheet 80, each sample image may also be annotated with an identifier 82 that identifies which set of color adjustment settings go with the sample. This annotation should be visible and readable by the user. The annotation may be embedded in the image or may be printed outside of the image (e.g., printed below, above, or to the side). Once the user has generated the proof sheet 80, the user may choose a particular sample image as having the desired color rendering. The user may then produce the final output of the job for the document/image data 50 by entering into the printer driver 58 the identifier 82 associated with the selected sample image, as illustrated in FIG. 13.

The printer driver uses the identifier 82 to retrieve the set of color adjustments associated with the identifier 82 and apply them to the final constructed print job. Additionally, the user can select an identifier 82 and make additional color adjustments relative to the color adjustments associated with the identifier 82 using a color adjustment menu 84. In some embodiments, the user can select an identifier 82 and then repeat the proofing process using color attribute settings 62 similar to those associated with the selected identifier 82 to further refine the output color rendering of the job.

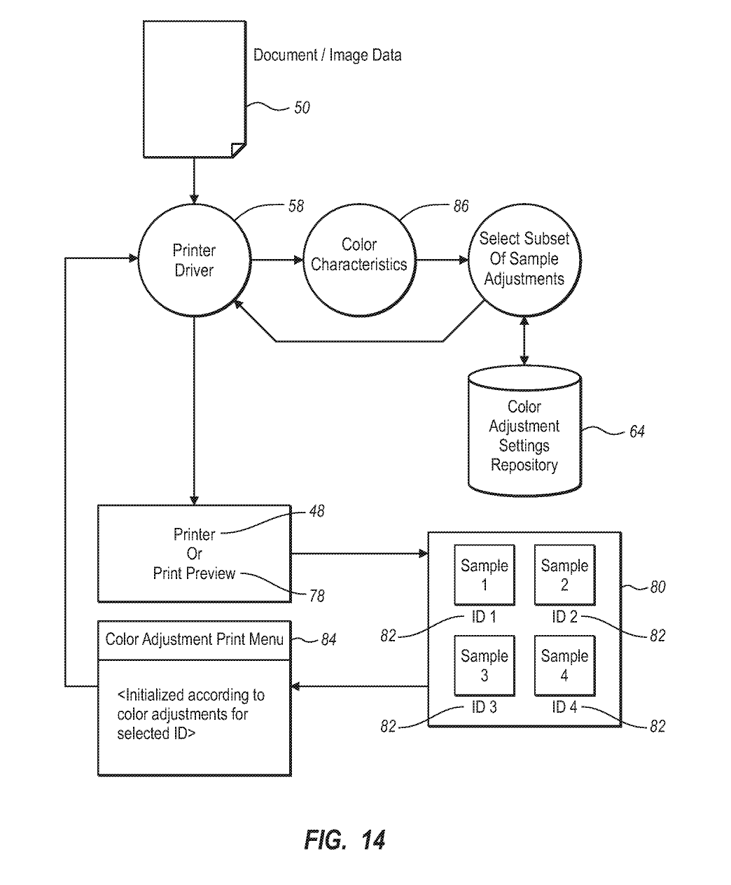

The printer driver 58 may also have a heuristic mechanism, as discussed above and illustrated in part in FIG. 14. In one example, the printer driver 58 preprocesses the job to determine color characteristics 86 of the job. The driver 58 then identifies a selected set of color attribute settings 62 from the color adjustment settings repository 64 and raises the weight (likelihood of matching) with the color characteristics 86 of the job. The selection of color attribute settings 62 using the heuristic mechanism may be partially or totally automatic, and may be based on the determined color characteristics 86 of the job, and may further be based on color characteristics 86 of past jobs and the corresponding selected color attribute settings 62 used with the past jobs. The printer driver 58 then may output an N-up output of proof print(s) using the selected (sample) color attribute settings 62 with identifiers 82 as set forth above, and the user may select an identifier 82 associated with the preferred color rendering and input additional adjustments to the selected color attribute settings 62 as set forth above.

Some embodiments may include a combination of user-selected color attribute settings 62 and automatically-selected color attribute settings 62. For example, in some embodiments, the user may be permitted to select some subset M of the N color attribute settings 62, and the other N-M color attribute settings 62 may be selected automatically based on a heuristic mechanism as described above, or by selecting color attribute settings 62 similar to those already selected by the user.

Other embodiments may include devices such as scanners, copiers, printers, facsimile devices, multi-function peripherals, filing devices, format converters, document/image servers, tablet PCs, electronic whiteboards, digital cameras, and CD burners. Other embodiments include, but are not limited to the print subsystems of the Microsoft Windows® operating system, Apple Macintosh® Operating System, Linux™ Operating System, System V Unix® Operating Systems, BSD Unix® Operating Systems, OSF Unix® Operating Systems, Citrix®, IBM® Mainframe MVS™ Operating System, and IBM® AS/400®. In some embodiments, the host device may be another connected imaging device (e.g., printer). The print preview display may also be remote from the host, such as a display connected to the device or an embedded device web page.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A method for color proofing comprising:
receiving a color rendering job;
selecting a portion of the color rendering job for color proofing;
outputting multiple copies of the portion as a single output job, each copy having a different set of color adjustment settings applied to it;
applying the color adjustment settings from a copy having a most desirable color rendering to the color rendering job; and
outputting the color rendering job using the color adjustment settings from the copy having the most desirable color rendering.

2. The method of claim 1 wherein the outputting the color rendering job is performed by a device selected from the group of:
a printer;
a copier;
a facsimile device;
a filing device;
a format conversion device;
a multifunction peripheral;
a duplication device;
a document/image server;
an electronic whiteboard; and
a digital projection system.

3. The method of claim 1 wherein the multiple copies of the portion output as a single output job are output as an N-up rendering job such that N copies of the multiple copies are simultaneously rendered on a single output display page.

4. The method of claim 1 wherein at least a portion of the different sets of color adjustment settings is selected by a user.

5. The method of claim 1 wherein at least a portion of the different sets of color adjustment settings is automatically selected.

6. The method of claim 5 wherein the automatically-selected sets of color adjustment settings are selected heuristically using color characteristics of the portion.

7. The method of claim 6 wherein the heuristic automatic selection of color adjustment settings is based on color characteristics of past jobs and on sets of color adjustment settings selected for the past jobs.

8. The method of claim 1, further comprising repeating the step of outputting multiple copies of the portion as a single output job until at least one copy of the portion has an acceptable color rendering, wherein each repetition uses at least one set of color adjustment settings that is different from the sets of color adjustment settings used in a previous repetition and that is selected relative to a best set of color adjustment settings from the previous repetition.

9. The method of claim 1 wherein at least a portion of the plurality of sets of color adjustment settings are selected from one of a temporary stored collection of color adjustment settings and a persistent stored collection of color adjustment settings.

10. A system for color proofing comprising:
a first color rendering job;
a color rendering device capable of receiving and rendering color rendering jobs; and
a color rendering generation system coupled to the color rendering device, the color rendering generation system comprising a computer program product for providing color adjustments to the first color rendering job and sending a second, adjusted, color rendering job to the color rendering device, said computer program product comprising a computer-usable medium having computer-readable program code thereon, said computer-readable program code comprising:
computer program code means for receiving the first color rendering job;
computer program code means for outputting multiple copies of a portion of the first color rendering job as a single output job, each copy having a different set of color adjustment settings applied to it, and each copy including an identifier identifying the set of color adjustment settings applied to that copy;
computer program code means for applying the color adjustment settings from a copy having a most desirable color rendering to the first color rendering job to create the second, adjusted, color rendering job; and
computer program code means for outputting the second, adjusted, color rendering job to the color rendering device.

11. The system of claim 10 wherein the color rendering generation system further comprises a means for storing multiple sets of color attribute settings.

12. The system of claim 11 wherein the means for storing multiple sets of color attribute settings comprises a color adjustment settings repository selected from a temporary color adjustment settings repository and a persistent color adjustment settings repository.

13. The system of claim 10 wherein the color rendering device is a device selected from the group of:
a printer;
a copier;
a facsimile device;
a filing device;
a format conversion device;
a multi-function peripheral;
a duplication device;
a document/image server;
an electronic whiteboard; and
a digital projection system.

14. The system of claim 10 wherein the multiple copies of the portion output as a single output job are output as an N-up rendering job such that N copies of the multiple copies are simultaneously rendered on a single output display page.

15. The system of claim 10 wherein the color rendering generation system and the color rendering device are parts of a single integral device.

16. A method for color print proofing comprising:
receiving a color print job;
selecting a portion of the color print job for color proofing;
outputting multiple copies of the portion as a single N-up output print job such that N copies of the multiple copies are printed on a single output page, each copy of the multiple copies having a different set of color adjustment settings applied to it;
applying the color adjustment settings from a copy having a most desirable color rendering to the color print job; and
outputting the color print job using the color adjustment settings from the copy having the most desirable color rendering.

17. The method of claim 16 wherein each copy of the portion is printed with an identifier identifying the set of color adjustment settings applied to the copy.

18. The method of claim 16 wherein at least one of the different sets of color adjustment settings are selected by a user and wherein at least one of the different sets of color adjustment settings is automatically heuristically selected using color characteristics of the portion, color characteristics of past jobs, and sets of color adjustment settings selected for the past jobs.

19. The method of claim 16, further comprising accessing a repository of color adjustment settings to select the sets of color adjustment settings applied to the portion.

20. The method of claim 16, further comprising providing a print preview of the portion showing simulated rendering of the portion with applied color adjustment settings.
